(19) United States
(12) Patent Application Publication
(10) Pub. No.: US 2009/0175437 A1
(43) Pub. Date: Jul. 9, 2009

(54) CALL TRANSFER BETWEEN DIFFERING EQUIPMENT

(75) Inventor: Malcom Strandberg, Cambridge, MA (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Aspect Software, Inc., Chelmsford, MA (US)

(21) Appl. No.: 11/970,825

(22) Filed: Jan. 8, 2008

(51) Int. Cl. H04M 3/50

(52) U.S. Cl. 379/265.09

(57) ABSTRACT

Generally, the invention is a device, method, and system for transferring a communication session from a first call center to a second call center. An exemplary system may have a first call center and a second call center. The first call center may have a first call management device, a call information posting device, and one or more agent communication terminals. The first call management device connects at least one telephone call from a customer to an agent communication terminal of the first call center. The call posting device produces a webpage of contact information associated with the customer. The second call center may have a second call management device different from the first call management device, a call information retrieving device, and one or more agent communication terminals. The call information retrieving device accesses the webpage. The second call management device uses the contact information to connect a call from an agent communication terminal of the second call center to the customer.

### TECHNICAL FIELD

The present invention relates to a call center and more particularly, to a device, method, and system for transferring customers from a first call center platform to a second call center platform.

### BACKGROUND INFORMATION

Call centers place telephone calls to customers. Customers may include current customers, previous customers, and individuals with information or with a desire to obtain additional information. The outbound platforms typically include an automated dialing system for contacting the customer. The automated dialing system is supplied with contact information for a list of customers associated with a campaign. When the automated dialing system reaches a busy number or unavailable customer, the communication session may be terminated and initiated again at a later time. When the automated dialing system reaches a live customer, the automated dialing system connects the live customer to an agent within a group of agents assigned to the campaign. The agent communicates the necessary information to the customer. Once the agent and customer have completed the communication session, the communication may be terminated and the agent is connected to the next live customer provided by the automated dialing system. Inbound platforms function similarly. Inbound platforms may handle a variety of calls placed by customers. The customer dials into the call center and is transferred to an agent that can assist them.

A growing number of businesses have begun using call centers to handle interactions with customers by way of telephone and/or other communication modes. Companies typically use call center services, for example, to manage outbound and inbound communications campaigns to potential customers for telemarketing or to existing customers for collections information or customer follow-up.

During the course of communication with a customer it may be determined that another call center would be able to better assist the customer. The call center may want to transfer the customer to another call center. However, the other call centers may use different equipment or protocols that prohibit a direct transfer. A direct transfer may also tie-up vital telephone lines by requiring the customer to communicate over a telephone line linked by the original call center.

Accordingly, a need exists for a device, method, and system to allow call centers to transfer customers between various call center platforms. The device, method, and system may also need to verify that the customer has been contacted by the second call center or maintain an interactive line of communication with the customer. In addition to transferring the communication session, the device, method, and system may also need to provide a standard and adaptable system with no special coding to retrofit call center platforms that may lack the ability to transfer calls to other call centers. In addition to transferring the communication session, the device, method, and system may also need to provide the most up-to-date contact information for a customer between call centers.

### SUMMARY

The present invention is a novel device, system, and method for transferring a communication session from a first call center to a second call center. An exemplary method may utilize a first call center including a first call management device and one or more agent communication terminals, and a second call center including a second call management device different from the first call management device and one or more agent communication terminals. The method may connect at least one telephone call from a customer using the first call management device of the first call center platform to an agent communication terminal of the first call center. The method may produce a webpage of contact information associated with the customer by the first call management device. The method may then access the webpage by the second call management device and may connect an agent communication terminal of the second call center to the customer. The method transfers the customer from the agent communication terminal of the first call center to the agent communication terminal of the second call center.

Exemplary embodiments may incorporate one or more of the following features. In one embodiment, the transfer of a communication session from a first call center to a second call center is an enterprise call transfer. In another embodiment, the contact information may be customer information stored by the first call center. In another embodiment, the action of transferring may involve the first call management device disconnecting the customer and the agent communication terminal of the first call center and attempting to reconnect to the customer to determine if a busy signal is present. In addition, when a busy signal is not detected the customer may be reconnected to the agent communication terminal of the first call center. In yet another embodiment, the action of transferring may involve maintaining the connection between the agent communication terminal of the first call center and the customer and disconnecting the connection after the customer transfers to the agent communication terminal of the second call center.

It is important to note that the present invention is not intended to be limited to a system or method which must satisfy one or more of any stated objects or features of the invention. It is also important to note that the present invention is not limited to the exemplary embodiments described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings wherein:

FIG. 1 is a system diagram used to provide transferring of calls between call centers of various platforms.

FIG. 2 is a flow chart illustrating a first exemplary embodiment of a method to provide transferring of calls between call centers of various platforms, according to the present invention.

FIG. 3 is a flow chart illustrating a first exemplary embodiment for determining if the second call center has contacted the customer, according to the present invention.

FIG. 4 a flow chart illustrating a second exemplary embodiment for determining if the second call center has contacted the customer, according to the present invention.

### DETAILED DESCRIPTION

The invention provides a configurable system that enables multiple call centers using a variety of call center equipment platforms to exchange information and cooperate to better serve a customer.

These call center platforms may operate independently according to their own equipment and protocols. The call center platforms may require not special code or specific platforms. The system may be used to transfer either inbound or outbound customers. When a customer reaches a call center, the call center may need to transfer the customer to a call center that may better provide the requested services. The system allows the call center to locate the desired call center and arrange for a transfer of the customer to the desired call center. When a call center reaches a given customer, it can process the customer and then make that customer available to other call centers. For example, if the customer was targeted by another outbound campaign at another call center, the campaign at the other call center may immediately use the contact instead of attempting to reach the customer as part of its normal processing and possibly miss the opportunity due to the customer being unavailable.

In one exemplary embodiment, an agent at a first call center alerts the customer that another campaign at another call center has shown interest in reaching the customer and then ask the customer if they desire to be reached by that call center. In another exemplary embodiment, the transfer of a customer can be made blindly; the campaign at the second call center may initiate a communication with the customer after the first one is done with the customer.

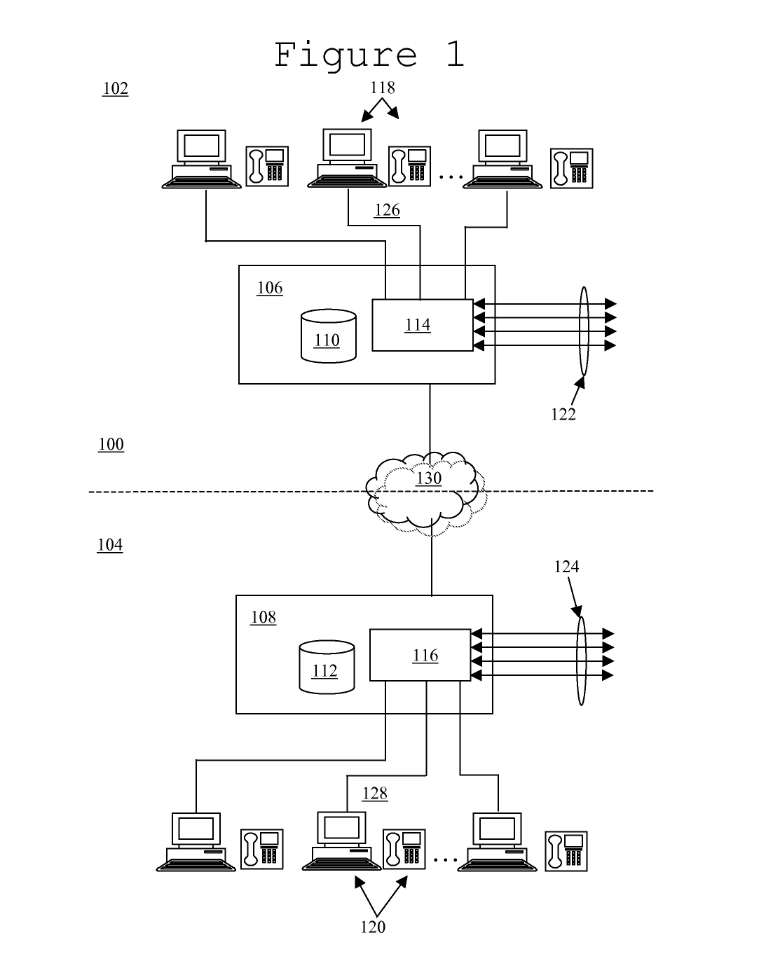

Referring to FIG. 1, a system 100 provides a communication network used to provide cooperation between different call center platforms. In the exemplary embodiment, a first call center 102 may transfer calls to and from a second call center 104. One of the call centers 102, 104, may be, for example, the type sold under the name Unison® by Aspect Software Inc. of Westford, Mass. This type of system is described in greater detail in U.S. Pat. No. 5,592,543 issued Jan. 7, 1997, assigned to the assignee of the present application and incorporated herein by reference. The other call center may use different equipment or protocols that may or may not be manufactured/supplied by Aspect Software.

The first call center 102 and the second call center 104 may each include a call management device 106, 108; a database 110, 112; and a switching device 114, 116. The call management devices 106, 108 connect the agent communication terminals 118, 120 to a customer via trunk communication lines 122, 124, respectively. The call management device 106, 108 accesses customer contact records that may be stored locally within the database 110, 112 of the respective call centers 102, 104. When the call management device 106, 108 reaches a busy number or unavailable customer, the communication session may be terminated and contacted again at a later time. When the call management device 106, 108 reaches a live customer, the call management device 106, 108 connects the live customer to an agent communication terminal 118, 120 within a group of agents 126, 128 assigned to the respective call centers 102, 104. The agent communications terminals 118, 120 may include, for example, a telephone, a computer, and other equipment used to relay information to and from the agent. The agent 126, 128 may then communicate the necessary information to the customer.

The call management device 106, 108 may receive requests for a call back by a customer at a remote location. The request may be transmitted from a webpage of an application running on a local customer computer connected to a network, such as the Internet/World Wide Web. The call management device 106, 108 receives the necessary information, for example a telephone number and customer identity, to place a call back to the customer via a web portal. The web portal may be an email or response form that is processed by the call management device for the necessary contact information. The call management device 106, 108 provides an automatic telephone call back to the customer who has requested assistance from a “live” agent of the call center. The details of “web callback’ and “click to chat” are described in greater detail in U.S. Pat. No. 6,879,674 issued Apr. 12, 2005, assigned to the assignee of the present application and incorporated herein by reference.

The present invention allows the call management device 106, 108 to utilize the web or email portal, previously used only to response to direct customer inquiries, to transfer calls between call centers without a special call transfer interface. The call center platform of each call center may operate independently according to their own equipment and protocols. The call center platforms may require no special code or specific platforms to provide for transfer of calls between call centers.

The call management device 106 may receive and connect a customer to an agent 126 within the call center 102. The agent 126 may determine that an agent at another call center 104 would better handle the customer. The agent 126 may instruct the call management device 106 to transfer the call to an agent 128 at the second call center 104. The call management device 106 may access the customer's contact information from the database and posts the contact information to an IP network 130. The call management device 108 of the second call center 104 accesses the posted contact information and connects the customer to one of the agent communication terminals 120 within the second call center 104.

The process may be accomplished in real time while the customer remains on the line with the agent 126 of the first call center 102. If the customer's telephone has the ability to tie in a second line, the customer may connect to the agent 128 of the second call center 104 without disconnecting from the first call center 102. This allows the customer to remain in contact with an agent 126, 128 during the entire process. If a customer does not have the ability to tie in multiple calls, the customer may disconnect with the agent 126 of the first call center 102 and wait for the call from the agent 128 of the second call center 104. The first call center 102 may wait a predefined period of time and place another call to the customer to verify the agent 128 of the second call center 104 has contacted the customer. This may be accomplished by identifying a busy signal when attempting to reconnect to the customer as will be discussed in greater detail later herein.

The posting of contact information may be on the World Wide Web to allow any call center platform with access to the World Wide Web the ability to transfer calls. The posting of contact information may be provided by a standardized application program interface that allows a variety of call centers platforms to utilize the information. The system 100 may also incorporate translators that may be used to convert the contact information from a format used by the first call center 102 to a format that may be utilized by the second call center 104. A variety of security measures, as would be appreciated by one skilled in the art, may be implemented to prevent access to the contact information by unauthorized parties.

The notification and retrieval of posted contact information may be performed in a variety of manners. For example, the second call center 104 may continuously poll the portal provided by the first call center 102. Once a transfer customer is detected, the second call center 104 may retrieve the contact information and connect the customer to an agent 128 of the second call center 104. In another example, the first call center 102 may send a notification message, for example, a message may be sent to a mailbox of the second call center 104. The message may direct the second call center 104 to the portal and provide access to the contact information of the customer to be transferred.

The above exemplary system 100 of the above call centers 102, 104 is for illustrative purposes. The embodiments of the present invention are not limited to the architecture of the exemplary system 100 shown in FIG. 1. Embodiment of the invention may be implemented in a variety of call center architectures. For example, the call centers 102, 104 may actually be within the same call center that uses different platforms within the call center. The system 100 may also be used to allow the transfer of calls within the same call center between different platforms. This call center architecture, as well as other call center architectures, are within the scope of the present invention. Software of an existing call center may be modified to utilize an Internet access port of the existing call center to implement the systems and methods of the invention.

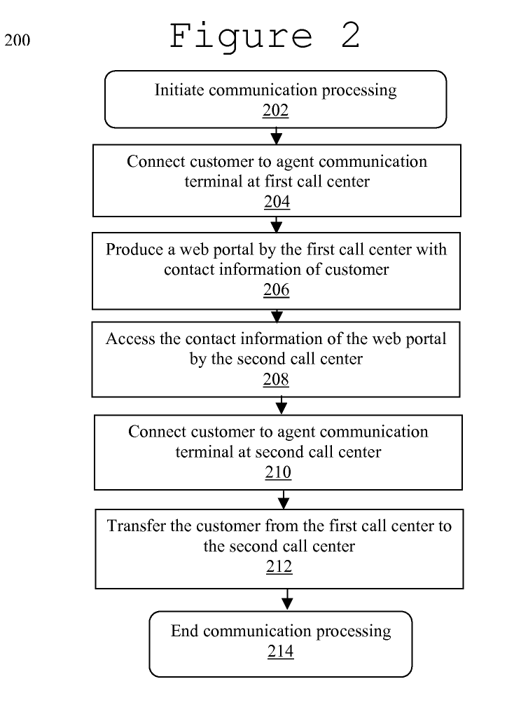

A flow chart illustrating a first exemplary embodiment 200 of the invention, shown in FIG. 2, enables a system to transfer a live customer to agents associated with the other call centers with different platforms. The first call management device 106 for the first call center 102 connects the customer to an agent communication terminal 118 (block 202). This may occur by the customer being contacted by an outbound campaign of the call center 102 or may be the result of the customer calling the first call center 102 as part of an inbound campaign. The agent communication terminal 118 is not limited to a human agent. The agent 126, 128 may be an automated response system that utilizes touch-tone selection or voice commands to assist the customer. During the course of the interaction between the agent 126 and the customer it may be determined that another call center would be better able to assist the customer. The agent 126 instructs the call management device 106 to transfer the customer.

The call management device 106 produces a web portal with contact information of the customer (block 206). The contact information may be a variety of information that will assist the second call center 104 in contacting and assisting the customer. The contact information posted may be information stored in a database 110 of the first call center 102 or information gathered by the agent 126 or other equipment during the initial interaction with the customer.

The second call center 104 accesses the contact information of the web portal (block 208). This may be accomplished as previously discussed. The call management device 108 may periodically poll the web portal to identify customers to transfer or may have a mailbox or other device that the first call center 102 uses to notify the second call center 104 of a customer requesting a transfer. The system is not limited to theses methods of notification. Other methods may be used to notify the other call centers and transmit the contact information. The second call management device 108 uses the contact information to connect an agent communication terminal with the customer (block 210). The customer is transferred from the first call center 102 to the second call center (block 212) and the communication process is complete (block 214).

The first exemplary embodiment 200, as well as other exemplary embodiments herein, illustrate the transfer of a customer from the first call center 102 to a second call center 104. One skilled in the art will appreciate that the transferring may occur in both directions. For example, a customer that is contacted with regard to a second call center 104 and also determined to be associated with a first call center 102 may be transferred to an agent 126 of the first call center 103.

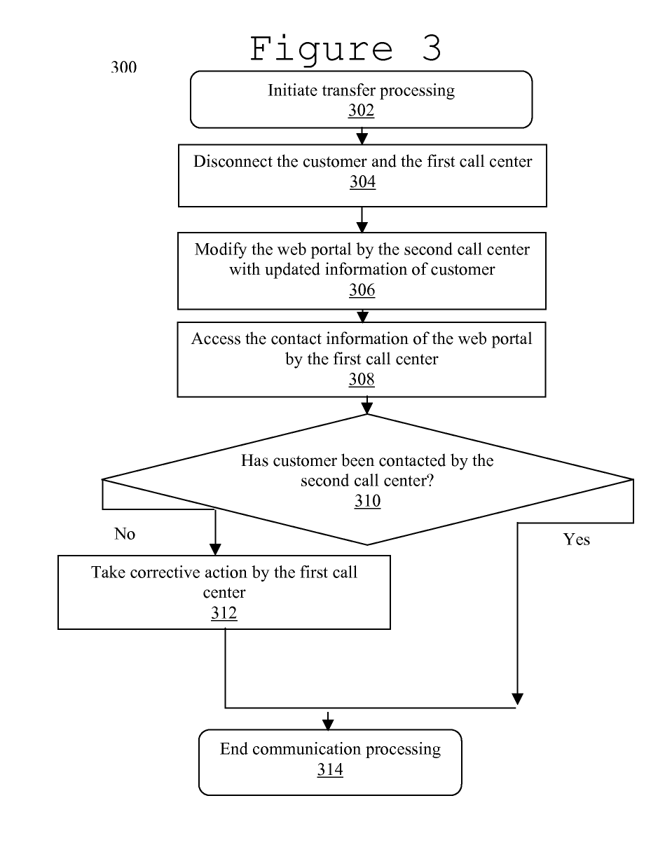

A flow chart illustrating a first exemplary embodiment 300 for determining whether the second call center 104 has contacted the customer is shown in FIG. 3. The method enables a system to ensure the second call center 104 has successfully contacted the customer after the first call center 102 and customer have disconnected. The transfer process is initiated as previously described in the first exemplary embodiment 200 (block 302). The first call management device 106 disconnects the customer and the first call center 102 (block 304). Once the second call center 104 accesses the contact information and contacts the customer, the second call center 104 updates the contact information of the web portal verifying the customer has been contacted (block 306). The first call center 102 accesses the web portal (block 308) and determines if the customer has been contacted by the second call center 104 (block 310).

If the second call center 104 has not contacted the customer (“No” branch of block 312), the first call center 102 takes the necessary corrective actions (block 312). This may include directly contacting the second call center 104 or contacting the customer and performing a direct transfer through a tie-line of the first call center 102 and the second call center. If the second call center 104 has contacted the customer (“Yes” branch of block 312), the communication process is complete (block 314).

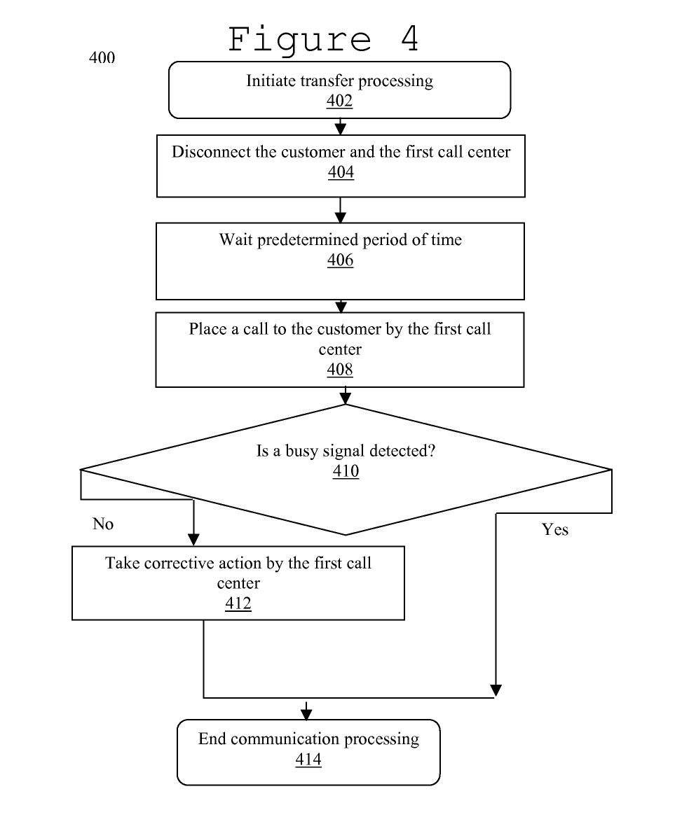

A flow chart illustrating a second exemplary embodiment 400 for determining if the second call center 104 has contacted the customer is shown in FIG. 4. The method enables a system to ensure the second call center 104 has successfully contacted the customer after the first call center 102 and customer have disconnected. The transfer process is initiated as previously described in the first exemplary embodiment 200 (block 402). The first call management device disconnects the customer and the first call center (block 404). A predetermined period of time passes (block 406). The predetermined period of time may be the time required for the second call center 104 to access the contact information and connect the customer to an agent 128 of the second call center 104. The period of time may take into account other factors as well. The first call center 102 places a call to the customer (block 408) and determines if a busy signal is present (block 410).

If no busy signal is detected (“No” branch of block 412), the first call center 102 take the necessary corrective actions (block 412). This may include directly contacting the second call center 104 or contacting the customer and performing a direct transfer through a tie-line of the first call center 102 and second call center. If a busy signal is detected (“Yes” branch of block 312), the first call center 102 may assume the customer has been contacted by the second call center 104 and the communication process is complete (block 314).

The exemplary embodiments described herein may be associated with the processor and memory associated with the campaign integrator or host computer for the campaigns. However, the aspects described in the exemplary embodiments may be implemented in a variety of digital electronic circuitry, or in computer hardware, firmware, software, or in combinations of them. The exemplary embodiments described herein can be implemented as a computer program product, i.e., a computer program tangibly embodied in an information carrier, e.g., in a machine-readable storage device or in a propagated signal, for execution by, or to control the operation of, a communications processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The present invention is not intended to be limited to a system, device, or method which must satisfy one or more of any stated or implied objects or features of the invention and is not limited to the exemplary embodiments described herein. Modifications and substitutions by one of ordinary skill in the art are considered to be within the scope of the present invention.

The invention claimed is:

1. A method of transferring a communication session from a first call center to a second call center, the first call center including a first call management device and one or more agent communication terminals, and the second call center including a second call management device different from the first call management device and one or more agent communication terminals, said method comprising:
connecting at least one telephone call from a customer using the first call management device of the first call center platform to an agent communication terminal of the first call center;
producing a webpage of contact information associated with the customer by the first call management device;
accessing the webpage by the second call management device;
connecting an agent communication terminal of the second call center to the customer by the second call management device; and
transferring the customer from the agent communication terminal of the first call center to the agent communication terminal of the second call center.

2. The method of claim 1 wherein the transferring a communication session from a first call center to a second call center is an enterprise call transfer.

3. The method of claim 1 wherein the contact information is customer information stored by the first call center.

4. The method of claim 1 wherein the action of transferring involves the first call management device disconnecting the customer and the agent communication terminal of the first call center and attempting to reconnect to the customer to determine if a busy signal is present.

5. The method of claim 4 wherein when a busy signal is not detected, the customer is reconnected to the agent communication terminal of the first call center.

6. The method of claim 1 wherein the action of transferring involves maintaining the connection between the agent communication terminal of the first call center and the customer and disconnecting the connection after the customer transfers to the agent communication terminal of the second call center.

7. The method of claim 1 wherein the second call center requires no specific platform.

8. A system for transferring a communication session from a first call center to a second call center comprising:
a first call center including a first call management device, a call information posting means, and one or more agent communication terminals wherein the first call management device connects at least one telephone call from a customer to an agent communication terminal of the first call center and the call posting means produces a webpage of contact information associated with the customer;
a second call center including a second call management device different from the first call management device, a call information retrieving means, and one or more agent communication terminals wherein the call information retrieving means accesses the webpage and the second call management device uses the contact information to connect a call from an agent communication terminal of the second call center to the customer.

9. The system of claim 8 wherein the transferring a communication session from a first call center to a second call center is an enterprise call transfer.

10. The system of claim 8 wherein the contact information is customer information stored by the first call center.

11. The system of claim 8 wherein the first call management device disconnects the customer and the agent communication terminal of the first call center and attempts to reconnect to the customer after a predetermined period of time to determine if a busy signal is present.

12. The system of claim 11 wherein when a busy signal is not detected, the first call management device reconnects the customer to the agent communication terminal of the first call center.

13. The system of claim 8 wherein the first call management device maintains the connection between the agent communication terminal of the first call center and the customer and disconnects the connection after the customer transfers to the agent communication terminal of the second call center.

14. The system of claim 8 wherein the agent communication terminal of the first call center is an automated response system.

15. A computer program product, tangibly embodied in an information carrier, for transferring a communication session from a first call center to a second call center, the first call center including a first call management device and one or more agent communication terminals, and the second call center including a second call management device different from the first call management device and one or more agent communication terminals, the computer program product being operable to cause a machine to:
connect at least one telephone call from a customer using the first call management device of the first call center platform to an agent communication terminal of the first call center;
produce a webpage of contact information associated with the customer by the first call management device;
access the webpage by the second call management device;
connect an agent communication terminal of the second call center to the customer by the second call management device; and
transfer the customer from the agent communication terminal of the first call center to the agent communication terminal of the second call center.

16. The computer program product of claim 15, wherein the contact information is customer information stored by the first call center.

17. The computer program product of claim 15, wherein action of transferring further comprises the computer program product being operable to cause the first call management device to disconnect the customer and the agent communication terminal of the first call center and attempt to reconnect to the customer to determine if a busy signal is present.

18. The computer program product of claim 17, wherein when a busy signal is not detected further comprising the computer program product being operable to cause the first call management device to reconnect the customer to the agent communication terminal of the first call center.

19. The computer program product of claim 15, wherein action of transferring further comprises the computer program product being operable to cause the first call management device to maintain the connection between the agent communication terminal of the first call center and the customer and disconnect the connection after the customer transfers to the agent communication terminal of the second call center.

20. The computer program product of claim 15, wherein the agent communication terminal of the first call center is an automated response system.
